(19) United States
(12) Patent Application Publication
(10) Pub. No.: US 2024/0044450 A1
(43) Pub. Date: Feb. 8, 2024

(54) DEVICE, SYSTEM AND METHOD OF MONITORING A STEAM TRAP AND DETECTING A STEAM TRAP FAILURE

(71) Applicant: 10855561 CANADA INC., Kitchener (CA)

(72) Inventors: Thomas Farnham Uhlenbruck, Kitchener (CA); Vivek Eknath Naik, Kitchener (CA); Bryan Neil Stephen Fedorak, Waterloo (CA); Jeffrey George Dayman, Waterloo (CA); Tyko Everest Van Vliet, Kitchener (CA); Brandon Cameron Chan, Kitchener (CA); Kecheng Li, Kitchener (CA); Kevin Zhang, Kitchener (CA)

(21) Appl. No.: 18/265,179

(22) PCT Filed: Dec. 4, 2020
(86) PCT No.: PCT/IB2020/061535

§ 371 Date: Jun. 2, 2023

(51) Int. Cl. F16T 1/48

(52) U.S. Cl. CPC F16T 1/48

(57) ABSTRACT

An example monitoring device for a steam trap includes: an enclosure; a sensor subsystem housed in the enclosure, the sensor subsystem to measure a property of the steam trap; a memory housed in the enclosure; a communications interface housed in the enclosure and configured to communicate with a server; a processor housed in the enclosure and interconnected to the sensor subsystem, the memory, and the communications interface, the processor configured to: obtain, from the sensor subsystem, data representing the property of the steam trap; extract a set of key features from the data; and send, via the communications interface, the set of key features to the server for further processing to detect a failure.

### FIELD

The specification relates generally to steam-powered systems, and more particularly to a device, system and method for monitoring a target device and detecting a failure of the target device.

### BACKGROUND

Systems, including pipe network systems, steam-powered systems, and the like may include various components, such as pumps, motors and traps, which may fail from time to time and negatively impact the systems in which they are deployed. For example, steam traps are utilized in steam lines of steam-powered processes to remove condensate from the steam line which may otherwise block the steam line and inhibit the steam-powered processes. Steam traps may fail when their valves fail to open or close as intended. Steam trap failures may be expensive due to loss of steam and hence generation of additional steam to replace the lost steam or may be detrimental to the steam-powered process if the condensate blocks the steam line.

### SUMMARY

According to an aspect of the present specification, a monitoring device for a steam trap is described. The monitoring device includes an enclosure; a sensor subsystem housed in the enclosure, the sensor subsystem to measure a property of the steam trap; a memory housed in the enclosure; a communications interface housed in the enclosure and configured to communicate with a server; a processor housed in the enclosure and interconnected to the sensor subsystem, the memory, and the communications interface, the processor configured to: obtain, from the sensor subsystem, data representing the property of the steam trap; extract a set of key features from the data; and send, via the communications interface, the set of key features to the server for further processing.

According to another aspect of the present specification, a method of detecting a failure of a steam trap is described. The method includes: obtaining, at a server, a set of key features representing steam trap data captured by a monitoring device of the steam trap; determining, based on the set of key features, whether a failure of the steam trap is detected; when a failure is detected, sending an alert to a client device; and outputting dashboard data to the client device.

According to another aspect of the present specification, a system for detecting a failure of a steam trap is described. The system includes: a server; and a monitoring device coupled to the steam trap, the monitoring device comprising: a sensor subsystem configured to measure a property of the steam trap; a processor interconnected to the sensor subsystem, the processor configured to: obtain, from the sensor subsystem, steam trap data representing the property of the steam trap; and extract a set of key features from the steam trap data; and send the set of key features to the server; wherein the server is configured to determine whether a failure of the steam trap is detected based on the set of key features received from the monitoring device.

### BRIEF DESCRIPTION OF DRAWINGS

Implementations are described with reference to the following figures, in which:

FIG. 1 is a schematic diagram of an example system for monitoring and detecting failures in steam traps;

FIG. 2 is a cross-sectional view of an example monitoring device in the system of FIG. 1;

FIG. 3 is a perspective view of an example mounting bracket for mounting the monitoring device of FIG. 2;

FIG. 4 is a block diagram of certain internal components of the monitoring device of FIG. 2;

FIG. 5 is a block diagram of certain internal components of a server in the system of FIG. 1;

FIG. 6 is a flowchart of an example method of monitoring and detecting failures in steam traps;

FIGS. 7A-C are flowcharts of example methods of extracting key features at block 610 of the method of FIG. 6; and

FIG. 8 is a flowchart of an example method of detecting a failure at block 630 of the method of FIG. 6.

### DETAILED DESCRIPTION

Failures of components of systems, such as steam-powered systems or other systems, may be costly and time-consuming to companies operating the systems. Accordingly, it may be desirable to monitor certain components or target devices which are prone to failing and which may significantly impact operations. Some solutions may include providing monitoring devices to monitor the target devices by capturing data, such as audio data, image data, temperature data, or the like, and analyze the data to detect a failure of the target device. Some monitoring devices may employ onboard circuitry to analyze the captured data, however such solutions are expensive, particularly when a facility or system requires hundreds or thousands of monitoring devices to monitor each target device. Further, since each target device is monitored individually, such systems do not provide overviews to the overall functional status of the entire facility. Accordingly, other monitoring devices may capture data and send the data to a central computing device for further processing. However, in order to send the captured data to the central computing device, the monitoring devices utilize high bandwidth communications protocols and hence may encounter challenges communicating the data over long ranges. The systems are therefore limited to localized computing devices and analysis.

The present disclosure describes a system including a monitoring device for monitoring a target device. The monitoring device includes a sensor subsystem for capturing data pertaining to the target device (e.g., audio data, vibration data, temperature data, etc.) and a processor capable of applying digital signal processing techniques to the captured data to extract a set of key features which are representative of the captured data, and which are also sufficiently concise enough to enable robust data transmission over a low-power wide-area network. That is, by applying signal processing on the monitoring device itself, large data sets may be reduced to a small set of key features, enabling the device to employ, for example Long Range (LoRa) communications, to send the set of key features to a cloud-based server. Further advantageously, since the set of key features is representative of the larger data sets, the cloud-based server may analyze the set of key features to determine the status of the target device. Thus, more memory intensive computations may be performed on the cloud rather than on individual devices.

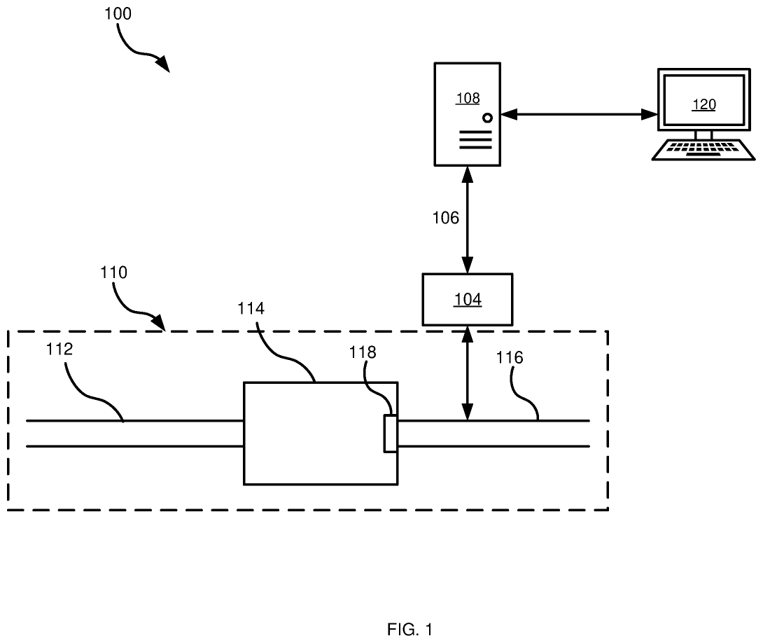

FIG. 1 depicts a system 100 for monitoring and detecting failures in a target device. The system 100 includes a monitoring device 104 in communication with a server 108 and, in the present example, is configured to monitor a steam trap 110 on a steam line (not shown).

The steam trap 110 includes an inflow line 112, a body 114, a condensate line 116, and a valve 118. In operation, steam and condensate of the steam flow from the steam line into the body 114 of the steam trap 110 via the inflow line 112. Condensate and other incondensable fluids are collected in the body 114, and when the body 114 accumulates a predefined volume of condensate, the valve 118 opens and releases the condensate into the condensate line 116. In particular, configuration and structure of the valve 118 and the inflow line 112 on the body 114 may allow the valve 118 to be opened to discharge condensate while discharging little steam from the steam line. For example the valve 118 may be a floating ball valve, or the like, which, when enough condensate is accumulated in the body 114, floats on the condensate to cause the valve 118 to open. As the condensate drains through the condensate line 116, the floating ball may be lowered, causing the valve 118 to close.

As will be appreciated, in operation, the valve 118 opens and closes regularly and may, from time to time, experience mechanical failures. For example, the valve 118 may fail in an open state, in which the valve 118 remains open, despite the body 114 containing less than the predefined volume of condensate accumulated therein. When the valve 118 fails in the open state, steam may escape from the open valve 118, causing a loss of steam in the steam line. Accordingly, the system generating the steam for the steam line may need to generate more steam in order to maintain the requisite amount of steam for the steam-powered process being serviced by the steam line. In other examples, the valve 118 may fail in a closed state, in which the valve 118 remains closed, despite the body 114 having accumulated more than the predefined volume of condensate. When the valve 118 fails in the closed state, condensate may back up the steam line and cause a process failure of the process being serviced by the steam line.

Accordingly, the monitoring device 104 is positioned proximate to the steam trap 110 to monitor one or more properties of the steam trap 110 and report said properties to the server 108 to detect a potential failure of the steam trap. For example, the monitoring device 104 may be mounted on a fluid line, such as the inflow line 112 or, preferably, on the condensate line 116 as illustrated in the present example. The monitoring device 104 therefore generally includes a plurality of sensors (e.g., a sensor subsystem) configured to measure properties of the steam trap. For example, the sensors may measure temperature data, audio data, vibration data, or the like. The monitoring device 104 is further configured to communicate with the server 108 and send data to the server 108 for further analysis. Preferably, the monitoring device 104 may communicate with the server 108 over a wide-area network, employing a communications protocol such as a Long Range (LoRa) protocol, or the like. In particular, the LoRa protocol is a low-power wide-area network communications protocol, and hence the bandwidth of data communicated from the monitoring device 104 to the server 108 may be limited. Accordingly, rather than sending all the data obtained from the sensors, the monitoring device 104 is further configured to extract a set of key features from the data obtained from the sensors and send the key features to the server 108 for further analysis. The structure, internal components and functionality of the monitoring device 104 are discussed in greater detail below.

The communications link 106 between the monitoring device 104 and the server 108 is preferably substantially wireless, and may include a combination of wired and wireless connections including direct links, or links that traverse one or more networks. For example, the communications link 106 may utilize networks including any one of, or any combination of suitable wide area networks (WAN) such as cellular networks, the internet or the like, any suitable local area networks (LAN) defined by one or more routers, switches, wireless access points, and the like. For example, the communications link 106 may include a first link via a Long Range (LoRa) network to a gateway, and a second link via an long-term evolution (LTE) network to the server 108.

The server 108 is generally configured to obtain the key features of the data obtained by the sensors of the monitoring device 104 and analyze them to determine a functional status of the steam trap 110. That is, the server 108 may determine, based on the key features, whether the steam trap 110 is functional, whether the valve 118 has failed in an open state, or whether the valve 118 has failed in a closed state. When a failure is detected at the steam trap 110, the server 108 may send a notification or alert to a client device 120, controlled, for example, by an operator of a facility in which the steam trap 110 is located. The server 108 may further aggregate and store the key features of the steam trap 110 and present the aggregate data to the client device 120. The internal components and functionality of the server 108 will be described in further detail below. As will be appreciated, in some examples, the functionality of the server 108 may be implemented on any suitable server environment, including a plurality of cooperating servers, a cloud-based server environment, and the like.

The client device 120 may be a computing device, such as a personal or desktop computer, a laptop, a tablet, a mobile device, another server, or the like. In the present example, a single client device 120 is illustrated, while in other examples, the server 108 may be in communication with multiple client devices 120. In particular, the client device 120 may be operated by an employee, such as a facility manager or operator of the facility in which the steam trap 110 is deployed. The client device 120 includes suitable hardware to communicate with the server 108, and in particular, to receive alerts or notifications and generate a visual or audio signals indicating said alerts and notifications (e.g., a speaker, a display, or the like). The client device 120 is further configured to receive dashboard data representing the measured properties of the steam trap 110, including historical data, from the server 108 and display the dashboard data to be viewed by a user of the client device 120. For example, an operator may utilize a personal computer as the client device 120 to access a web application to view the dashboard data. Further, as will be appreciated, the alerts and notifications and the viewing of the dashboard data may occur at different client devices 120.

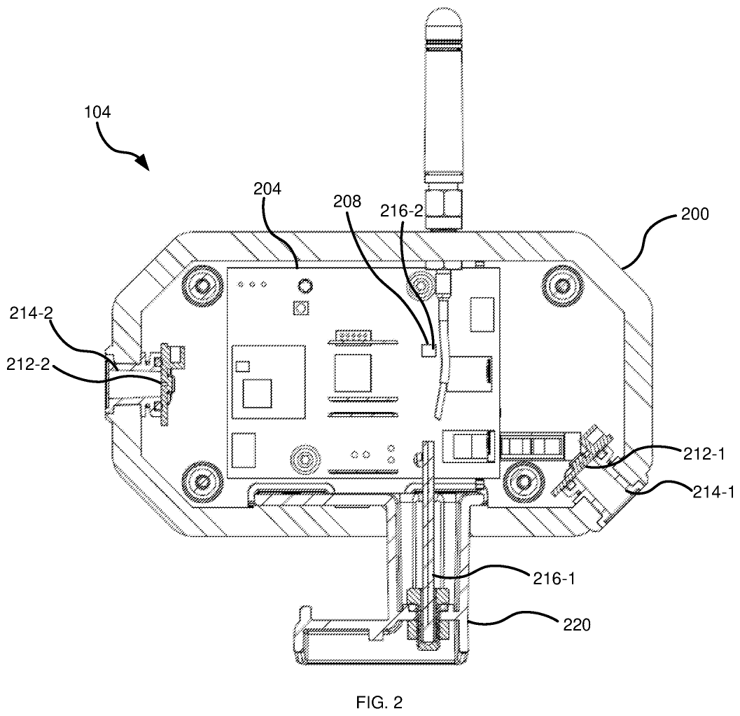

Referring to FIG. 2, a cross-sectional view of the monitoring device 104 is depicted. The monitoring device 104 includes an enclosure 200, the enclosure housing a circuit board 204, an accelerometer 208, two microphones 212-1 and 212-2 (referred to generically as a microphone 212 and collectively as the microphones 212; this nomenclature is used elsewhere herein), and two temperature sensors 216-1 and 216-2. The monitoring device 104 may further include a mounting bracket 220 coupled to the enclosure 200 and configured to mount the monitoring device 104 on a fluid line (e.g., a steam line, the inflow line 112, or the condensate line 116).

The enclosure 200 is generally configured to house the internal components of the monitoring device 104 and protect the internal components from damage. The enclosure 200 may include plastics, such as polyphenylene sulfide (PPS), polymers, metals, combinations of the above, and the like. For example, the enclosure 200 may be formed by injection molding a plastic material. Preferably, the enclosure 200 is formed of a heat-resistant material to reduce heat transfer from the fluid line on which the monitoring device 104 is mounted to the monitoring device 104 itself, and in particular, its internal components.

The circuit board 204 may be a printed circuit board (PCB) supporting the electronic components, which will be described in further detail below, as well as one or more sensors. For example, in the present example, the circuit board 204 supports the accelerometer 208 and the secondary temperature sensor 216-2 as a component of the accelerometer 208.

The accelerometer 208 may be any suitable motion detection sensor configured to measure the motion, and in particular, the vibration of steam trap 110. More particularly, the accelerometer 208, being supported on and attached to the enclosure 200 of the monitoring device 104, measures the vibration of the monitoring device 104. The monitoring device 104, in turn, may be mounted on the condensate line 116 of the steam trap 110 and hence vibrations at the steam trap 110 are propagated through to the monitoring device 104, allowing detection by the accelerometer 208.

The microphones 212 may be any suitable sensor configured to capture audio data representing sound generated by the steam trap 110 as well as sound from the environment of the steam trap 110 (e.g., background noise). In the present example, the monitoring device 104 includes a microphone 212-1 and a secondary microphone 212-2. In operation, the monitoring device 104 may be oriented such that the microphone 212-1 is facing in a direction towards the steam trap 110, while the secondary microphone 212-2 is facing in a direction away from the steam trap 110. Accordingly, the microphone 212-1 may primarily capture sound generated by the steam trap 110, while the secondary microphone 212-2, oriented away from the steam trap 110, is configured to capture secondary audio data representing sound from the environment of the steam trap (i.e., background noise).

In some examples, to further limit the sound received at the microphones 212, the enclosure 200 may include barrels 214-1 and 214-2 extending between the microphones 212 housed within the enclosure 200 and an exterior surface of the enclosure 200. The barrels 214 may be formed as separate components configured to mate with the enclosure 200 or may be formed integrally with the enclosure 200. The barrels 214 may have a slight conical shape, being narrower at an end proximate the respective microphones 212 and wider at an opposite end (i.e., the end distal from the respective microphones 212). In other examples, the barrels 214 may have different shapes, including distinct walls, curved walls, or similar, to tune the audio data captured at the respective microphones 212. The microphones 212 are positioned within the enclosure 200 at the respective internal ends of the barrels 214.

The barrels 214 may further serve to substantially limit the audio data captured at the microphones 212 to sound originating within a sector originating at the respective microphone 212 and defined by the corresponding barrel 214. For example, the microphone 212-1 is oriented towards the steam trap 110, and hence the barrel 214-1 is oriented between the microphone 212-1 and the steam trap 110. The barrel 214-1 is therefore configured to limit the audio data captured at the microphone 212-1 to sound originating substantially from a direction corresponding to a direction of the steam trap 110. That is, based on the orientation of the monitoring device 104 and therefore the microphone 212-1 and the barrel 214-1, the microphone 212-1 primarily captures sound generated by the steam trap 110, while the barrel 214-1 blocks or otherwise limits sound originating from other directions from reaching the microphone 212-1. That is, the barrel 214-1 causes the microphone 212-2 to be substantially unidirectional. Similarly, the secondary microphone 212-2 and barrel 214-2 cooperate to limit the audio data captured by the secondary microphone 212-2 to sound generated from a direction away from the steam trap 110, as defined relative to the monitoring device 104.

The microphones 212 may additionally include a narrow bandpass filter configured to attenuate frequencies outside a predefined range. For example, when the steam trap 110 fails with the valve 118 in the open state, the loss of steam via the valve 118 may cause the steam trap 110 to emit a an ultrasound soundwave having a frequency in of about 40 kHz. Accordingly, the microphone 212-1, which is configured to capture audio data representing sound generated by the steam trap 110, may employ a narrow bandpass filter passing frequencies within the range of about 35 kHz to about 45 kHz and attenuate frequencies outside said range. In other examples, the bandpass filter may be wider or narrower, or have a different center based on the expected frequency of noise emitted by the steam trap 110 when the valve 118 fails in the open state. As will be appreciated, the microphone 212-1 and the secondary microphone 212-2 may employ bandpass filters for different ranges of frequencies, based on the target sounds to be captured by the respective microphones 212.

The monitoring device 104 further includes a temperature sensor 216-1 and a secondary temperature sensor 216-2. The temperature sensors 216 may be thermometers or other suitable sensors configured to capture temperature data. In particular, the temperature sensor 216-1 is configured to capture temperature data representing an approximate temperature of the condensate line 116 of the steam trap 110, while the secondary temperature sensor 216-2 is configured to capture secondary temperature data representing an internal temperature of the enclosure 200. That is, the secondary temperature sensor 216-2 may also be supported on the circuit board 204 housed within the enclosure 200 to measure the temperature of an interior of the enclosure 200.

In order to capture the temperature of the condensate line 116, the temperature sensor 216-1 may be positioned proximate the condensate line 116. In particular, the monitoring device 104 may be mounted on the condensate line 116 via the mounting bracket 220.

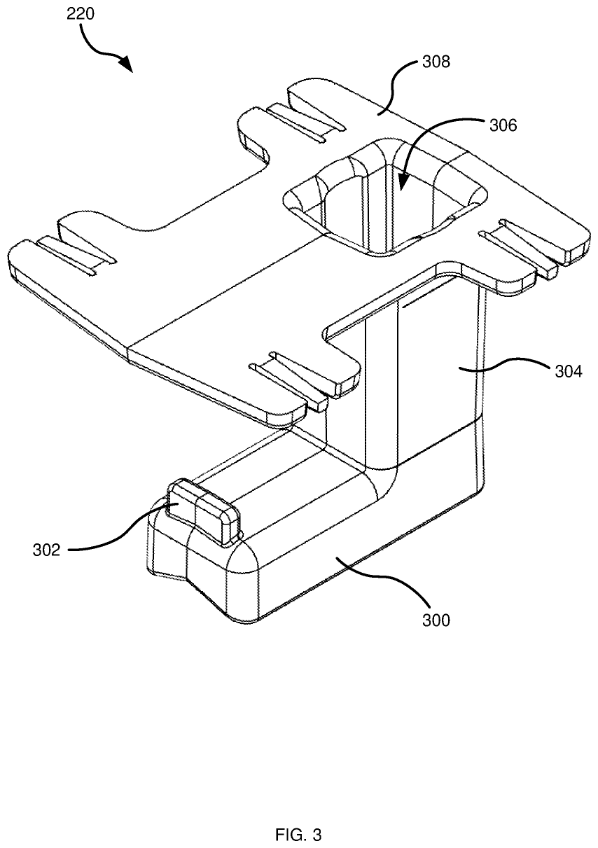

For example, referring to FIG. 3, a perspective view of the mounting bracket 220 is shown. The mounting bracket 220 includes a mounting arm 300, a channel 304 extending from the mounting arm 300, and a plate 308 coupled to the channel 304 and spaced apart from the mounting arm 300.

The mounting arm 300 is generally configured to mate with a fluid line (e.g., the condensate line 116). Preferably, the mounting arm 300 may have a V-shape to reduce heat transfer from the fluid line to the monitoring device 104 via the mounting bracket 220. That is, the fluid line may be configured to nestle within the interior of the V-shape of the mounting arm 300. Based on the generally cylindrical shape of fluid lines (i.e., pipes) and the V-shape of the mounting arm 300, the fluid line contacts the mounting arm 300 only at points along two lines (e.g., rather than along an entire surface). The V-shape further provides ventilation at the apex of the V-shape to further reduce heat transfer. Additionally, the V-shape allows the mounting bracket 220 to mate with fluid lines having a variety of diameters while maintaining the reduction in heat transfer.

The mounting arm 300 may be secured to the fluid line via a clamp, tie, chain, or other suitable fastener as will be apparent to those of skill in the art. In some examples, the mounting arm 300 may include a stopper 302 extending from an end to maintain the fastener on the mounting arm 300 (i.e., to stop the fastener from sliding off an end of the mounting arm 300).

The mounting bracket 220 further includes the channel 304 extending from the mounting arm 300. The channel 304 is generally enclosed and provides a space 306 to accommodate a sensor of the monitoring device 104. For example, the temperature sensor 216-1 may be supported in the enclosure 200 and extend into the space 306 of the channel 304 to situate the temperature sensor 216-1 closer to the fluid line it is to measure the temperature of. The accommodation of the temperature sensor 216-1 within the channel 304 is illustrated in FIG. 2. Thus, when the monitoring device 104 is mounted on the condensate line 116, the accommodation of the temperature sensor 216-1 within the channel 304 allows the temperature sensor 216-1 to be positioned closer to the condensate line 116 to capture temperature data more accurately representing the temperature of the condensate line 116.

Returning to FIG. 3, the channel 304 further serves to space the plate 308 apart from the mounting arm 300. That is, the plate 308 may be coupled to the channel 304 at an opposite end to the mounting arm 300. The plate 308 is configured to mate with the enclosure 200 to support the monitoring device 104 on the mounting bracket 220. For example, the plate 308 may be received in the enclosure 200 within the enclosure 200 (i.e., in an interior of the enclosure 200) and may include slots and tabs or pins configured to interface with corresponding slots and tabs or pins of the enclosure 200 to couple the enclosure 200 to the plate 308. In other examples, the plate 308 may be coupled to the enclosure 200 outside the enclosure 200 (e.g., the enclosure 200 may be secured to a top or open face of the plate 308). Further, in other examples, screws, clamps, clips, or other suitable fasteners as may be contemplated by those of skill in the art may alternately or additionally be used to secure the enclosure 200 to the plate 308 such that the monitoring device 104 may be mounted on a fluid line via the mounting bracket 220.

Other variations are also contemplated. For example, in the presently illustrated example, the mounting bracket 220 is a separate component from the enclosure 200. In other examples, the mounting bracket 220 and the enclosure 200 may be integrally formed. That is, the enclosure 200 may be formed with a channel extending therefrom, and a mounting arm at the end of the channel.

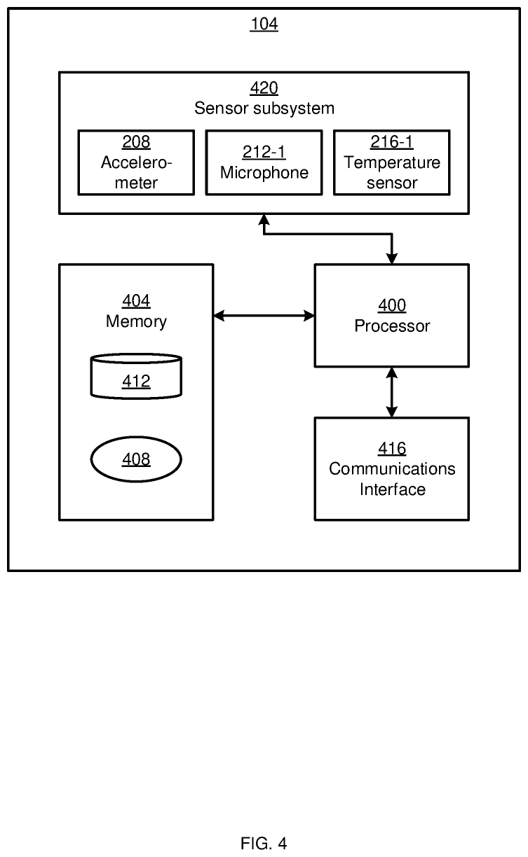

Referring now to FIG. 4, a block diagram of certain electronic components of the monitoring device 104. The monitoring device 104 includes a processor 400, a memory 404, a communications interface 416 and a sensor subsystem 420, each housed in or supported within the enclosure 200. For example, the processor 400, the memory 404 and the communications interface 416 may be supported on the circuit board 204.

The processor 400 may be a central processing unit (CPU), a microcontroller, a processing core, or similar. The processor 400 may include multiple cooperating processors. In some examples, the functionality implemented by the processor 400 may be implemented by one or more specially designed hardware and firmware components, such as a field-programmable gate array (FPGA), an application-specific integrated circuit (ASIC), a digital signal processing (DSP) processor and the like. In some examples, the processor 400 may be a special purpose processor which may be implemented via dedicated logic circuitry of an ASIC, an FPGA, a DSP processor, or the like in order to enhance the processing speed of the monitoring operation discussed herein.

The processor 400 is interconnected with a non-transitory computer-readable storage medium, such as a memory 404. The memory 404 may include a combination of volatile memory (e.g., random access memory or RAM) and non-volatile memory (e.g., read only memory or ROM, electrically erasable programmable read only memory or EEPROM, flash memory). The processor 400 and the memory 404 may comprise one or more integrated circuits. Some or all of the memory 404 may be integrated with the processor 400. The memory 404 stores computer-readable instructions for execution by the processor 400. In particular, the memory 404 stores a control application 408 which, when executed by the processor 400, configures the processor 400 to perform various functions discussed below in greater detail and related to the steam trap monitoring operation of the monitoring device 104. The application 408 may also be implemented as a suite of distinct applications. The memory 404 may also store a repository 412 containing, for example, rules, thresholds, and other data for use in the steam trap monitoring operation of the monitoring device 104.

The monitoring device 104 also includes the communications interface 416 interconnected with the processor 400. The communications interface 416 includes suitable hardware (e.g., transmitters, receivers, network interface controllers and the like) allowing the monitoring device 104 to communicate with other computing devices, specifically the server 108. The specific components of the communications interface 416 are selected based on the type of network or other links, including the communication link 106 that the monitoring device 104 is to communicate over.

The monitoring device 104 also includes the sensor subsystem 420. The sensor subsystem 420 in the present example is illustrated as including the accelerometer 208, the microphone 212-1 and the temperature sensor 216-1. In other examples, the sensor subsystem 420 may include additional sensors, including, but not limited to, the secondary microphone 212-2 and the secondary temperature sensor 216-2, as well as other suitable sensors. In still further examples, the sensor subsystem 420 may include a subset of or alternate sensors to the ones illustrated and described herein.

In some examples, the monitoring device 104 may also include one or more input and/or output devices (not shown) interconnected with the processor 400. The input devices can include one or more buttons, keypads, touch-sensitive display screens or the like for receiving input, for example from an operator. The output devices can include one or more display screens, sound generators, vibrators or the like for providing output or feedback.

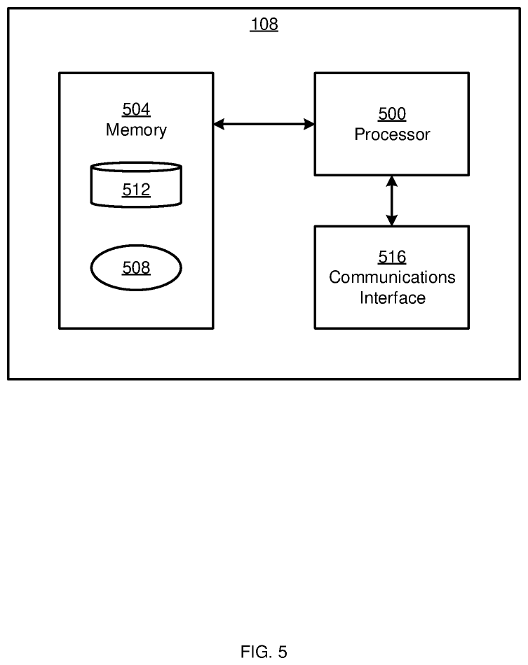

Turning to FIG. 5, the server 108, including certain internal components, is shown in greater detail. The server 108 includes a processor 500, such as a central processing unit (CPU), a microcontroller, a processing core, or similar. The processor 500 may include multiple cooperating processors. In some examples, the functionality implemented by the processor 500 may be implemented by one or more specially designed hardware and firmware components, such as a FPGA, ASIC and the like. In some examples, the processor 500 may be a special purpose processor which may be implemented via dedicated logic circuitry of an ASIC, an FPGA, a DSP processor, or the like in order to enhance the processing speed of the failure determination operation discussed herein.

The processor 500 is interconnected with a non-transitory computer-readable storage medium, such as a memory 504. The memory 504 may include a combination of volatile memory (e.g., random access memory or RAM) and non-volatile memory (e.g., read only memory or ROM, electrically erasable programmable read only memory or EEPROM, flash memory). The processor 500 and the memory 504 may comprise one or more integrated circuits. Some or all of the memory 504 may be integrated with the processor 500. The memory 504 stores computer-readable instructions for execution by the processor 500. In particular, the memory 504 stores a control application 508 which, when executed by the processor 500, configures the processor 500 to perform various functions discussed below in greater detail and related to the steam trap failure determination operation of the server 108. The application 508 may also be implemented as a suite of distinct applications. The memory 504 may also store a repository 512 containing, for example, rules for use in the steam trap failure determination operation (e.g., related to threshold values or ranges or other conditions defining a steam trap failure), as well as previously received steam trap data. In other examples, the memory 504 and/or the repository 512 may also store other rules and data pertaining to the steam trap failure determination operation of the system 100.

The server 108 also includes a communications interface 516 interconnected with the processor 500. The communications interface 516 includes suitable hardware (e.g., transmitters, receivers, network interface controllers and the like) allowing the server 108 to communicate with other computing devices, specifically the monitoring device 104 and the client device 120. The specific components of the communications interface 516 are selected based on the type of network or other links, including the communication link 106 that the server 108 is to communicate over.

In some examples, the server 108 may also include one or more input and/or output devices (not shown), interconnected with the processor 500. The input devices can include one or more buttons, keypads, touch-sensitive display screens or the like for receiving input from an operator. The output devices can include one or more display screens, sound generators, vibrators or the like for providing output or feedback.

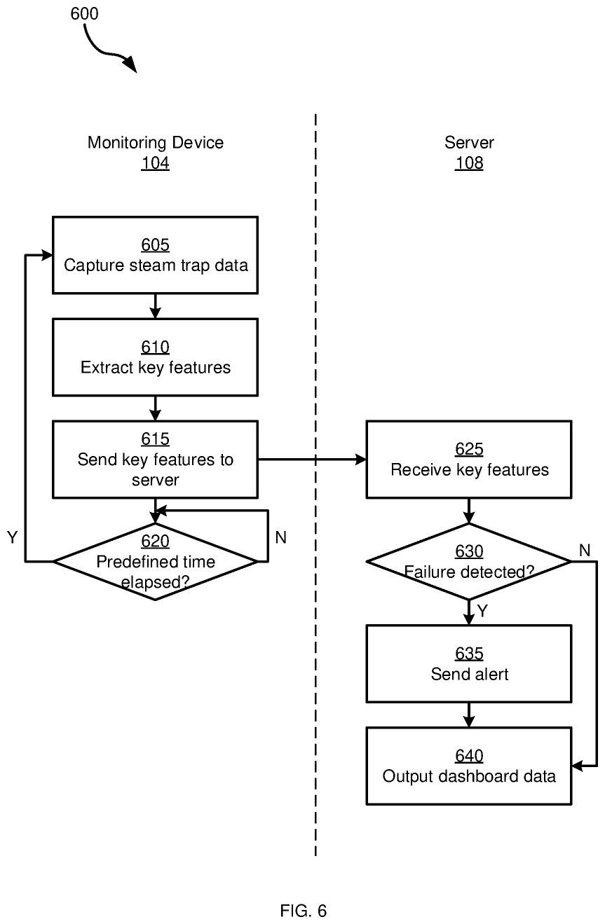

The operation of the system 100, as implemented via execution of the applications 408 and 508 by the processors 400 and 500 respectively, will now be described in greater detail. FIG. 6 illustrates a method 600 of monitoring a steam trap and detecting a failure of the steam trap. The method 600 will be described in conjunction with its performance in the system 100 with reference to the components illustrated in FIGS. 1 to 5. In other examples, the method 600 may be performed by other suitable devices and/or systems.

The method 600 begins at block 605. At block 605, the monitoring device 104 captures steam trap data representing one or more properties of the steam trap 110. For example, the monitoring device 104 may capture audio data representing sound generated by the steam trap 110 using the microphone 212-1, temperature data representing the approximate temperature of the condensate line 116 using the temperature sensor 216-1 and vibration data representing vibration caused by the steam trap 110 and experienced by the monitoring device 104. In some examples, the steam trap data captured at block 605 may further include secondary audio data representing sound from the environment of the steam trap 110 captured by the secondary microphone 212-2 and secondary temperature data representing the internal temperature of the enclosure 200 of the monitoring device 104. In still further examples, further steam trap data may be captured using other sensors of the sensor subsystem 420.

At block 610, the monitoring device 104 extracts a set of key features from the steam trap data captured at block 605. In particular, the set of key features form a representative sample of the steam trap data captured at block 605 to allow the server 108 to make an accurate determination of the functional status of the steam trap 110, while reducing the data set to a sufficiently small size to allow the set of key features to be packetized and sent to the server 108 via a low-power wide-area network, such as using a LoRa communications protocol.

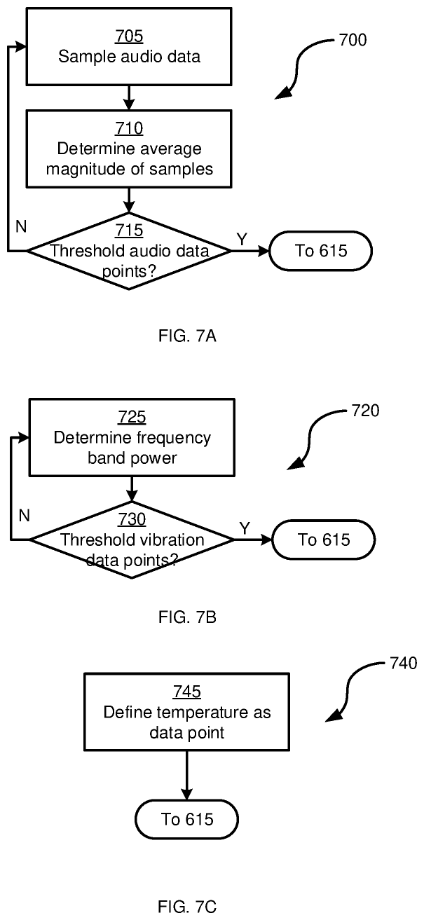

For example, referring to FIG. 7A, an example method 700 of processing the audio data captured by the microphone 212-1 to extract audio data points to be included in the set of key features is depicted. In other examples, the method 700 may be applied to the secondary audio data captured by the microphone 212-2.

At block 705, the monitoring device 104, and in particular the processor 400, samples the audio data captured by the microphone 212-1 at a predefined number of points over or at predefined time intervals. That is, the monitoring device 104 determines the magnitude of the detected audio data at discrete points in time over or at the predefined time interval. For example, the monitoring device 104 may sample the audio data 300 times at intervals of about 1 millisecond. In other examples, the monitoring device 104 may sample the audio data sample the audio data about 100 times, or about 2000 times, or other suitable sample rates. Further, in other examples, the sampling may be performed at time intervals of 3 milliseconds, 10 milliseconds, or other suitable time intervals.

At block 710, the monitoring device 104 determines an average value of the magnitude of the samples obtained at block 705 (i.e., an average magnitude of the sampled audio data). This average value is defined as an audio data point to be included in the set of key features.

At block 715, the monitoring device 104 determines whether a threshold number of audio data points has been obtained. If the threshold number of audio data points has been obtained, the monitoring device 104 ends the method 700 and returns to block 615 of the method 600. If the threshold number of audio data points has not been obtained, the monitoring device 104 returns to block 705 to obtain further audio data points. For example, the threshold number of data points may be about 20 data points. The threshold number of audio data points may be defined, for example, in the repository 412 and selected based on the bandwidth capacity of the communications interface 416. That is, the threshold number of audio data points is selected to provide sufficient information to the server 108 to analyze the audio data, while maintaining robust data transmission from the monitoring device 104 to the server 108, in particular, over a low-power wide-area network.

Referring now to FIG. 7B, an example method 720 of processing the vibration data captured by the accelerometer 208 to extract vibration data points to be included in the set of key features is depicted.

At block 725, the monitoring device 104, and in particular the processor 400, determines the frequency band power of the vibration data over a predefined time interval. That is, the monitoring device 104 determines the vibration frequency having the strongest power over the predefined time interval. The frequency band power over the predefined interval is defined as a vibration data point to be included in the set of key features.

At block 730, the monitoring device determines whether a threshold number of vibration data points has been obtained. If the threshold number of vibration data points has been obtained, the monitoring device 104 ends the method 720 and returns to block 615 of the method 600. If the threshold number of vibration data points has not been obtained, the monitoring device returns to block 725 to obtain further vibration data points. For example, the threshold number of vibration data points may be about 20 data points. The threshold number of vibration data points may be defined, for example, in the repository 412 and selected based on the bandwidth capacity of the communications interface 416. That is, the threshold number of vibration data points is selected to provide sufficient information to the server 108 to analyze the vibration data, while maintaining robust data transmission from the monitoring device 104 to the server 108, in particular, over a low-power wide-area network.

Referring now to FIG. 7C, an example method 740 of processing the temperature data captured by the temperature sensor 216-1 to extract a temperature data point to be included in the set of key features is depicted. In other examples, the method 740 may be applied to

At block 745, the monitoring device 104 defines the temperature recorded by the temperature sensor 216-1 as a temperature data point to be included in the set of key features. In particular, the temperature sensor 216-1 may be configured to measure the temperature at a single discrete point in time, and hence no further processing to obtain a discrete data point for the set of key features may be necessary. The monitoring device 104 may then proceed to block 615 of the method 600.

It will be appreciated that in other examples, other methods of sampling the audio data, vibration data and temperature data may be employed to extract audio data points, vibration data points and temperature data points to be included in the set of key features. For example, rather than obtaining the temperature recorded at a single discrete point in time, the monitoring device 104 may determine the average temperature recorded over a predefined interval of time. Other manners of sampling continuous signals to obtain a predefined number of discrete data points which are representative of the continuous signals are also contemplated.

Returning to FIG. 6, after having extracted the key features of the steam trap data, the monitoring device 104 proceeds to block 615 of the method 600. At block 615, the monitoring device 104 sends the set of key features to the server 108 using the communications interface 416. In particular, since the monitoring device 104 and the server 108 be distant from one another, the communications link 106 may traverse a wide-area network, and hence the communications interface 416 may employ a LoRa communications protocol. In addition to the set of key features, the monitoring device 104 may additionally transmit identification data pertaining, for example, to the monitoring device 104 itself, the steam trap 110, the facility in which the steam trap 110 is deployed, or the like.

At block 620, the monitoring device 104 determines whether a predefined amount of time has elapsed since sending the key features to the server. If the predefined amount of time has elapsed, the monitoring device 104 returns to block 605 to capture new data and provide periodically updated steam trap data to the server 108. If the predefined amount of time has not yet elapsed, the monitoring device 104 continues to wait until the predefined amount of time has elapsed. In some examples, the monitoring device 104 may be configured to revert to a low power or sleep state until the predefined amount of time has elapsed in order to conserve power and energy. The predefined amount of time may be, for example, 5 minutes, 10 minutes, 30 minutes, 1 hour, or other suitable time periods. Further, in some examples, each data type (e.g., audio data, vibration data, temperature data) may correspond to a different predefined amount of time for which to obtain updated data. For example, audio data and vibration data may be captured every 30 minutes, while temperature data may be captured every 5 minutes.

At block 625, the server 108 obtains the set of key features from the monitoring device 104 and proceeds to block 630 for further processing. In some examples, prior to proceeding to block 630, the server 108 may first extract the secondary temperature data from the set of key features to evaluate the working condition of the monitoring device. In particular, if the temperature data point representing the internal temperature of the enclosure 200 exceeds a threshold temperature, the server 108 may determine that the temperature conditions of the monitoring device 104 exceed acceptable operational thresholds, and hence the data captured by the sensors may be inaccurate. Accordingly, the server 108 may generate an alert and send the alert to the client device 120, warning an operator of inoperable conditions of the monitoring device 104.

At block 630, the server 108 determines, based on the set of key features, whether a steam trap failure is detected.

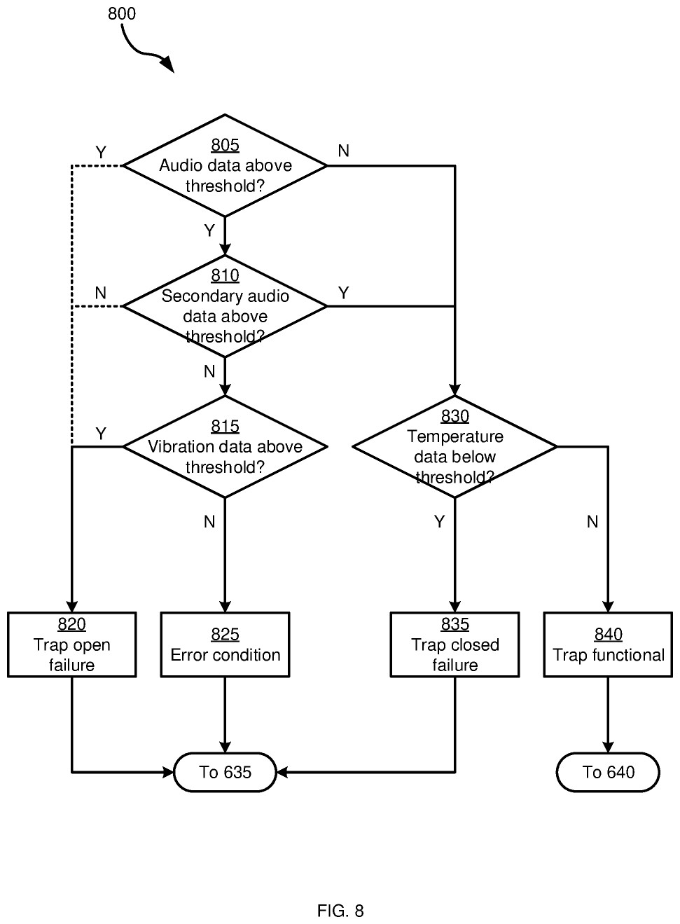

For example, referring to FIG. 8, an example method 800 of identifying a steam trap failure is illustrated. The blocks of the method 800 may be performed concurrently and/or in an order different from that depicted, and accordingly are referred to as blocks and not steps. For example, the server 108 may analyze the temperature data concurrently with the audio data and the vibration data, rather than sequentially.

At block 805, the server 108 determines whether the audio data points exceed a threshold magnitude. In some examples, the server 108 may determine that the audio data points from the set of key features exceed the threshold magnitude when a majority (or threshold percentage) of the audio data points exceed the threshold magnitude. In other examples, the server 108 may require that all the audio data points from the set of key features exceed the threshold magnitude or that at least one of the audio data points from the set of key features exceed the threshold magnitude. Notably, since the narrow bandpass filter attenuates frequencies outside the predefined range, audio data points having a magnitude above the threshold magnitude are indicative of the captured audio data being within the predefined range corresponding to the valve 118 failing in the open state.

Further, in some examples, the server 108 may determine whether the audio data points exceed the threshold magnitude for at least a threshold amount of time (e.g., 2 hours, 6 hours, 1 day, or another suitable amount of time). In particular, in some examples, the server 108 may therefore consider the historical data of the audio data points. That is, the server 108 may retrieve audio data points from previously received sets of key features (e.g., as stored in the repository 512). For example, the server 108 may first determine whether a threshold percentage of the audio data points exceed the threshold magnitude. If the determination is positive, the server 108 may retrieve the historical data of the audio data points to determine whether the audio data points have exceeded the threshold magnitude for at least 2 hours (i.e., whether the previous four sets of audio data points have also exceeded the threshold magnitude).

The threshold magnitude and the specific conditions for which the determination of block 805 are satisfied may be defined in the repository 512. In some examples, the threshold magnitude may be dynamically determined, for example with respect to a baseline ambient noise. In other examples, the threshold magnitude may be dynamically determined based on previously recorded audio data (i.e., to detect changes in pattern of the audio data over time).

If the audio data points are determined to exceed the threshold magnitude, the server 108 may determine that the audio data is indicative of the steam trap 110 failing with the valve 118 in the open state. Further, the determination that the audio data points have exceeded the threshold magnitude for at least a threshold amount of time (i.e., traversing more than one set of audio data points) may indicate that the failure is ongoing rather than temporary. In some examples, after a positive determination at block 805, the server 108 may proceed directly to block 820 (as indicated by the dashed line). In other examples, after a positive determination at block 805, the server 108 may proceed to block 810 to validate the determination of a trap open failure. If the determination at block 805 is negative, the server 108 determines that the valve 118 has not failed in an open state and may proceed to block 830 for further analysis.

At block 810, the server 108 validates the determination of the trap open failure using the secondary audio data. In particular, the server 108 determines whether the secondary audio data points from the secondary audio data also exceed the threshold magnitude. The threshold magnitude and specific conditions for which the determination is affirmative may be similar to those for the audio data points and may be defined in the repository 512.

If the secondary audio data points are also determined to exceed the threshold magnitude, such data may be indicative that the sound detected by the microphone 212-1 is not generated by the steam trap 110, but is present in the environment (e.g., the facility) of the steam trap 110, and accordingly, may not correspond to a failure of the steam trap 110. Specifically, since each of the microphones 212 capture sound substantially directionally, with the microphone 212-1 capturing sound from the direction of the steam trap, and the secondary microphone 212-2 capturing sound originating away from the direction of the steam trap, the captured audio data within the same frequency range indicates that the captured audio data is generated from an omni- or multi-directional source, or from multiple sources, rather than originating from the steam trap 110 itself.

Accordingly, if the determination at block 810 is affirmative, the server 108 may determine that the valve 118 has not failed in an open state and may proceed to block 830 for further analysis. If the determination at block 810 is negative, the server 108 may proceed, in some examples to block 820 (as indicated by the dashed line), and in other examples, to block 815 to further validate the determination of the trap open failure.

At block 815, the server 108 determines whether the vibration data points exceed a threshold magnitude. That is, the server 108 determines whether the vibration data indicate that the monitoring device 104 is vibrating with above a certain frequency. For example, the determination may be made with respect to whether a threshold percentage of the vibration data points exceed the threshold magnitude. The threshold magnitude and the specific conditions for which the determination of block 815 are satisfied may be defined in the repository 512. For example, the threshold magnitude may be dynamically determined based on a baseline vibration frequency, relative to previously recorded vibration data to detect changes in patterns of the vibration data over time, or the like. In particular, if the vibration data points are determined to exceed the threshold magnitude, the vibrations experienced by the monitoring device 104 may be indicative that the steam trap 110 has failed with the valve 118 in the open state. That is, the steam escaping through the open valve 118 may cause vibrations in the condensate line 116 which are propagated through to the monitoring device 104.

Accordingly, if the determination at block 815 is affirmative, the server 108 proceeds to block 820. If the determination at block 815 is negative, the server 108 proceeds to block 825.

At block 820, the server 108 determines that, based on the set of key features obtained at block 625, the steam trap 110 has failed in the open state. The server 108 then proceeds to block 635.

At block 825, the server 108 determines that, based on the set of key features obtained at block 625, the steam trap 110 may have failed, but that the data is unclear. For example, the audio data may indicate that the steam trap 110 has failed in the open state, but this conclusion is not supported by the vibration data, which does not demonstrate sufficiently high vibration frequencies to support a conclusion of a trap open failure. Accordingly, the data may require further analysis, for example with overview by a facility operator. The server 108 then proceeds to block 635.

At block 830, the server 108 determines whether the temperature data point obtained from the temperature sensor 216-1 is below a threshold temperature. In some examples, the server 108 may further determine whether the temperature has been below the threshold temperature for at least a threshold amount of time (e.g., 30 minutes, 2 hours, 6 hours, or another suitable amount of time). In particular, the server 108 may therefore consider historical data of the temperature data points. That is, the server 108 may retrieve temperature data points from previously received sets of key features (e.g., as stored in the repository 512). Hence, to determine whether the temperature has been below the threshold temperature for at least 30 minutes, the server 108 may determine whether the previous six sets of temperature data points have also been below the threshold temperature.

If the temperature data point(s) are determined to be below the threshold temperature, the server 108 may determine that the temperature data is indicative of the steam trap 110 failing with the valve 118 in the closed state. That is, the condensate contained in the body 114 is generally warm and may continually be slightly warmed by the nearby steam. Thus, when the condensate is emptied into the condensate line 116, the condensate warms the condensate line 116 as well. When the condensate line 116 remains cool for an extended period, this may be indicative that the valve 118 is not opening periodically to release the condensate contained in the steam trap 110. That is, when the condensate line 116 remains below the threshold temperature, these conditions are indicative that the valve 118 has failed in the closed state.

Accordingly, if the determination at block 830 is affirmative, the server 108 proceeds to block 835. If the determination at block 830 is negative, the server 108 proceeds to block 840.

At block 835, the server 108 determines that, based on the set of key features obtained at block 625, the steam trap 110 has failed in the closed state. The server 108 then proceeds to block 635.

At block 840, the server 108 determines that, based on the set of key features obtained at block 625, the steam trap 110 is functional. The server 108 then proceeds to block 640 to present dashboard data to the client device.

In some examples, some of the blocks described above may be skipped or may be optional based on the configuration of the monitoring device 104, the set of key features received by the server 108, or other factors. For example, if the monitoring device 104 includes a single microphone, the method 800 may proceed from block 805 directly to block 815 when the audio data indicates a trap open failure to validate the trap open failure using the vibration data. Other combinations are also contemplated.

Returning to FIG. 6, at block 635, having detected a failure, the server 108 generates and sends an alert to the client device 120. The alert may be an email notification, a text message, a push notification from an associated application, a visual (e.g., pop-up) indicator, an audio indicator, or other suitable alerts. The alert may further include the details of the detected failure, such as an identification of the steam trap 110 (e.g., an identification name or number, including a location of the steam trap 110 within the facility in which it is deployed), an indication of the type of failure detected (e.g., trap open failure, trap closed failure, error condition/indeterminate failure), and the like.

At block 640, the server 108 aggregates the set of key features with previously received sets of key features into dashboard data to be presented in a visual dashboard at the client device 120. The dashboard data is then output to the client device 120. The dashboard data may aggregate the data for display as charts, graphs, or other visual aids to present the performance of the steam trap 110 to an operator of the client device 120. Further, in some examples, the dashboard data may aggregate the sets of key features and performance data of multiple steam traps, for example, which are all deployed in a given facility.

As described above, a monitoring device may be configured to monitor a target device and capture data pertaining to the target device. The monitoring device applies on-board digital signal processing to reduce the captured data to a set of key features representative of the captured data. The set of key features is selected to be sufficiently detailed to allow a server to perform meaningful analysis while being concise enough to enable the monitoring device to employ LoRa or other low-power, wide-area network communications.

In the present example, the target device is a steam trap; in other examples, the monitoring device may be employed to monitor other target devices including but not limited to pumps, motors, or other components which may experience periodic failures. As will be appreciated, in such examples, the monitoring device may employ suitable sensors to capture data for determining a failure of the target device. For example, the sensor subsystem may include image sensors, infrared sensors, microphones, temperature sensors, and the like. Further, the conditions under which a failure is detected may be selected according to the specific failure conditions of the target device (e.g., capturing audio data in a different frequency range, identifying a visual indicator of a failure, such as a color change of a component, or similar).

The scope of the claims should not be limited by the embodiments set forth in the above examples, but should be given the broadest interpretation consistent with the description as a whole.

1. A monitoring device for a steam trap, the monitoring device comprising:
an enclosure;
a sensor subsystem housed in the enclosure, the sensor subsystem to measure a property of the steam trap;
a memory housed in the enclosure;
a communications interface housed in the enclosure and configured to communicate with a server;
a processor housed in the enclosure and interconnected to the sensor subsystem, the memory, and the communications interface, the processor configured to:
obtain, from the sensor subsystem, data representing the property of the steam trap;
extract a set of key features from the data; and
send, via the communications interface, the set of key features to the server for further processing.

2. The monitoring device of claim 1, wherein the sensor subsystem includes a microphone configured to capture audio data representing sound generated by the steam trap.

3. The monitoring device of claim 2, wherein the enclosure includes a barrel oriented between the microphone and the steam trap, the barrel configured to limit the audio data captured at the microphone to sound originating substantially from a direction corresponding to a direction of the steam trap.

4. The monitoring device of claim 2, wherein the sensor subsystem further includes a secondary microphone oriented away from the steam trap, the secondary microphone configured to capture secondary audio data representing sound from an environment of the steam trap.

5. The monitoring device of claim 2, wherein the microphone is further configured to apply a narrow bandpass filter to the audio data to attenuate frequencies outside a predefined range.

6. The monitoring device of claim 2, wherein the processor is configured to:
sample the audio data at a predefined number of points at predefined time intervals;
determine an average magnitude of the sampled audio data; and
define the average magnitude as an audio data point to be included in the set of key features.

7. The monitoring device of claim 1, wherein the sensor subsystem includes a temperature sensor configured to capture temperature data representing a temperature of a condensate line of the steam trap.

8. The monitoring device of claim 7, wherein the processor is configured to define the temperature of the condensate line as a temperature data point to be included in the set of key features.

9. The monitoring device of claim 1, wherein the sensor subsystem further includes a secondary temperature sensor configured to capture secondary temperature data representing an internal temperature of the enclosure.

10. The monitoring device of claim 9, wherein the processor is configured to define the internal temperature of the enclosure as a temperature data point to be included in the set of key features.

11. The monitoring device of claim 1, wherein the sensor subsystem includes an accelerometer configured to capture vibration data representing vibration experienced by the monitoring device.

12. The monitoring device of claim 11, wherein the processor is configured to:
determine a frequency band power of the vibration data over a predefined time interval; and
define the frequency band power as a vibration data point to be included in the set of key features.

13. The monitoring device of claim 1, further comprising a mounting bracket coupled to the enclosure, the mounting bracket to mount the monitoring device on a fluid line proximate the steam trap.

14. The monitoring device of claim 13, wherein the mounting bracket comprises:
a mounting arm configured to mate with the fluid line;
a channel extending from the mounting arm, the channel configured to accommodate a sensor of the sensor subsystem; and
a plate coupled to the channel and spaced apart from the mounting arm, the plate configured to mate with the enclosure to support the monitoring device on the mounting bracket.

15. The monitoring device of claim 14, wherein the mounting arm comprises a V-shape to reduce heat transfer from fluid line to the monitoring device.

16. The monitoring device of claim 1, wherein the communications interface is configured to employ a low-power wide-area network communications protocol.

17. A method of detecting a failure of a steam trap, the method comprising:
obtaining, at a server, a set of key features representing steam trap data captured by a monitoring device of the steam trap;
determining, based on the set of key features, whether a failure of the steam trap is detected;
when a failure is detected, sending an alert to a client device; and
outputting dashboard data to the client device.

18. The method of claim 17, wherein determining whether a failure of the steam trap is detected comprises:
determining whether audio data points from the set of key features exceed a threshold magnitude; and
when the audio data points exceed the threshold magnitude, determining that the steam trap has failed in an open state.

19. The method of claim 18, wherein determining whether the audio data points from the set of key features exceed a threshold magnitude comprises determining whether a threshold percentage of the audio data points exceed the threshold magnitude.

20. The method of claim 18, wherein determining whether a failure of the steam trap is detected further comprises:
determining whether secondary audio data points from the set of key features exceed the threshold magnitude; and
when the secondary audio data points do not exceed the threshold magnitude, validating that the steam trap has failed in an open state.

21. The method of claim 18, wherein determining whether a failure of the steam trap is detected further comprises:
determining whether vibration data points from the set of key features exceed a threshold vibration magnitude; and
when the vibration data points exceed the threshold vibration magnitude, validating that the steam trap has failed in an open state.

22. The method of claim 17, wherein determining whether a failure of the steam trap is detected comprises:
determining whether a temperature data point from the set of key features is below a threshold temperature; and
when the temperature data point is below the threshold temperature, determining that the steam trap has failed in a closed state.

23. The method of claim 17, wherein the alert comprises one or more of: an email notification, a text message, a push notification, a visual indicator and an audio indicator.

24. The method of claim 17, wherein the dashboard data comprises an aggregation of the set of key features with one or more of: previously received sets of key features and sets of key features of further steam traps.

25. A system for detecting a failure of a steam trap, the system comprising:
a server; and
a monitoring device coupled to the steam trap, the monitoring device comprising:
a sensor subsystem configured to measure a property of the steam trap;
a processor interconnected to the sensor subsystem, the processor configured to:
obtain, from the sensor subsystem, steam trap data representing the property of the steam trap; and
extract a set of key features from the steam trap data; and
send the set of key features to the server;
wherein the server is configured to determine whether a failure of the steam trap is detected based on the set of key features received from the monitoring device.
